(19) United States
(12) Patent Application Publication
(10) Pub. No.: US 2015/0277093 A1
(43) Pub. Date: Oct. 1, 2015

(54) PROCEDURE FOR TERMINATING MICROSCOPIC APPLICATIONS WITH AN IMMERSION OBJECTIVE

(71) Applicant: Carl Zeiss Microscopy GmbH, Jena (DE)

(72) Inventors: Peter Schön, Gottingen (DE); Ralf Steinmeyer, Hannover (DE); Thorsten Kues, Bovenden-Eddigehausen (DE)

(21) Appl. No.: 14/617,351

(22) Filed: Feb. 9, 2015

(30) Foreign Application Priority Data
Mar. 28, 2014 (DE) 102014004511.0

(51) Int. Cl. G02B 21/33; G02B 21/36; G02B 21/26

(52) U.S. Cl. CPC G02B 21/33; G02B 21/26; G02B 21/365

(57) ABSTRACT

A method for terminating microscopic applications with an immersion objective, in particular for switching between the immersion objective and a dry objective or a further immersion objective, wherein after the microscopic application, the immersion objective or the microscope stage bearing a specimen and/or a specimen container is moved from the observation position. The immersion medium remaining on the specimen and/or on the specimen container is deposited at a location outside the observation position of the terminated microscopic application or a further microscopic application.

### RELATED APPLICATIONS

The present application claims priority to German Application No. 10 2014 004 511.0 filed Mar. 28, 2014, said priority application being incorporated herein in its entirety by reference.

### FIELD OF THE INVENTION

The invention relates to a procedure for terminating microscopic applications with an immersion objective, in particular for switching between the immersion objective and a dry objective or a further immersion objective, wherein after the microscopic application, the immersion objective or the microscope stage bearing a specimen and/or a specimen container is moved from the observation position.

### BACKGROUND OF THE INVENTION

Objectives form an integral component in microscopes. There are objectives with many different magnifications and resolving powers. Objectives with a higher magnification typically also have a higher resolving power than low-magnification objectives. For objectives with particularly high resolution, the space between the objective and the specimen is immersed with a liquid, which may be water or oil, for example. These objectives are therefore also referred to as immersion objectives. In contrast, objectives without immersion are called dry objectives.

An example examination procedure using an inverted microscope is described below. The objective is situated beneath the specimen. In addition, the further description always refers to an inverted configuration.

The aim is to examine living cells with regard to how they respond when certain substances are added. An overview image of the specimen is created, using a low-magnification dry objective. Regions in the overview image which are to be investigated in greater detail are subsequently detected. This may take place with the aid of suitable image analysis, for example. For the further detailed observation, a higher-magnification, higher-resolution immersion objective is swiveled in, the immersion medium is applied to the objective, and after addition of the reagents the previously designated areas are observed in a time series, for example. After the time series with the immersion objective, an overview image of the specimen is to be recorded again. This is generally necessary, since for living cell specimens the overview recording may vary over time. It is therefore necessary to update the overview image in order to detect the region for the next time series which is to be recorded with the immersion objective. For this purpose, a switch must be made to the dry objective.

However, when the dry objective is now swiveled in again, a problem arises. The immersion medium remains on the front lens of the immersion objective as well as on the underside of the specimen container. When the immersion objective is swiveled out, the immersion medium may run downwardly along the objective and into the microscope, resulting in damage. Depending on the quantity of the immersion medium, this may be intercepted by an Aqua Stop. Alternatively, the droplet may be suctioned off. The droplet on the specimen container may once again form an immersion film when the dry objective is swiveled in. However, since a dry objective is not designed for this purpose, this results in serious imaging errors to the point of completely unusable results. Even if no immersion film forms due to the fact that the distance between the front lens of the dry objective and the specimen container is too large, in order to bring the objective into contact with the residual droplet, the droplet distorts the image at the location of the specimen container on which it is present. In manual microscopes, the user can withdraw the specimen container, remove the immersion medium and reinsert it, and continue with the examination. However, the difficulty then lies in finding the original location again. In particular in automated microscopes, in which predefined experiment runs are carried out, such an interaction is neither wanted nor possible. Thus, the residual droplet of the immersion medium represents a source of error with potentially serious consequences.

EP 2180363 describes a method for observing a position of the specimen with a dry objective after the observation with an immersion objective. For this purpose, the stage is moved to a position that is outside the area which is to be observed immediately afterward with the dry objective. The objective switch is then made at that location. The stage subsequently moves back to its original position. The first observation position after the switch is therefore not adversely affected by the immersion droplet, but this is not true for further possible observation positions, since these positions do not play a role in the lateral movement of the stage.

### SUMMARY OF THE INVENTION

The object of embodiments of the present invention, therefore, is to describe a procedure for terminating microscopic applications with an immersion objective, in particular for switching between the immersion objective and a dry objective or a further immersion objective, by means of which in an experiment run it is possible the continue the experiment after the microscopic application with the immersion objective has terminated, without the immersion medium which remains on the specimen container adversely affecting the further experiment.

According to embodiments of the invention, the immersion medium remaining on the specimen and/or on the specimen container is deposited at a location outside the observation position of the terminated microscopic application or a further microscopic application.

When a switch is made between the immersion objective and a dry objective or a further immersion objective, this takes place by:

creating a preview image of the specimen and/or the specimen container and/or the specimen holder on the microscope stage;

determining coordinates of the microscope stage and/or the objective from the preview image;

moving the microscope stage and/or the objective to a position of the specimen and/or of the specimen container which does not represent an observation position;

depositing the immersion medium residual droplet outside the observation position;

switching the objectives outside the observation position; and

moving the microscope stage and/or the objective to the observation position of the dry objective.

The preview image may be created either at a particular location in the microscope or directly in the normal beam path, for example if a low-magnification dry objective is to be swiveled in. The stage coordinates or the coordinates of the objective for each point of the specimen container are then determined from the preview image.

Under some circumstances, this preview also provides information concerning which portions of the specimen container contain relevant specimens and which do not. A suitable image recognition function may also carry this out in an automated manner. For example, when a microtiter plate is used as the specimen container, the areas between the individual wells may be automatically recognized and used for the subsequent objective switch.

When a switch is made between an immersion objective and a dry objective or a further immersion objective, on the basis of the preview image the microscope stage or the objective moves to a position of the specimen container which does not represent a potential observation position. The objective switch takes place at this location. The microscope stage or the objective subsequently moves to the observation positions which are to be observed with the new objective.

There are many different types of specimen containers. Examples include covered specimen carriers, Petri dishes, and, as previously mentioned, microtiter plates.

In covered specimen carriers, the specimen is situated between the specimen carrier and a cover glass. The non-covered locations of the specimen carrier are not suitable here for the objective switch. Alternatively, the cover glass areas beneath which no specimen is present may be used.

In Petri dishes, the areas close to the edge are suitable, since these areas are usually not relevant for the investigations. Therefore, the objective switch may advantageously be carried out at that location.

Microtiter plates have a plurality of individual wells which may contain specimens. The number of wells varies, depending on the type of plate. For example, 24, 96, or 384 wells may be present.

Possible switch locations are empty wells or, as previously mentioned, the areas between individual wells. It is then necessary only to store these locations for the subsequent experiment run in order to avoid the situation that, during the switch between the observations of two wells, the microscope stage moves in such a way that it guides the deposited immersion medium residual droplet along, above the front lens, and the dry objective is inadvertently wetted.

It is advantageous when the switch location is situated outside the specimen container surface area. The microscope stage or the objective may thus move until the holder of the specimen container is above the objective. The immersion residual droplet may be deposited at that location as well. However, the underside of the specimen container holder often is not situated in the same plane as the underside of the specimen container. In order for the specimen container to rest stably, the holders are generally constructed in such a way that their underside is situated slightly lower, for example 0.5 mm, than the underside of the specimen container.

Since immersion objectives frequently have only very small working distances, i.e., the front lens is very close to the base of the specimen container, there is a risk of the holder and stage colliding when the stage is moved far enough to deposit the immersion medium residual droplet on the holder. Of course, the objective revolver may be correspondingly lowered, but this process increases the complexity of the objective switch, and in addition there is a risk of the immersion film tearing off during the lowering, so that the immersion medium residual droplet cannot be deposited on the holder, and instead is already caught at the observation position. For this reason, switch locations in the area of the specimen container base are preferred over those at the specimen container holder.

Other embodiments of specimen containers are also conceivable. The specimen also does not necessarily have to be situated in a specimen container. For material testing, the specimen may be situated directly on the microscope stage. Whatever configuration is used, it is generally apparent to the user which regions are to be examined, and at which locations it is certain that an examination will not take place. The positions during the switch from an immersion objective to a dry objective may be deduced on this basis.

The definition of the switch locations may take place automatically based on a preview image. If an objective switch is to take place, the system moves, for example, to the nearest meaningful switch position, switches the objective, and subsequently continues the experiment. No further user interaction is necessary for this purpose. Alternatively, the user may define where an objective switch is to take place. This can, for example, take place for uncommon specimen containers.

In addition, for microtiter plates having a very large number of wells, for example 384 or 1536 wells, where there possibly may not be enough space between individual wells for the immersion medium residual droplet to be deposited, it is meaningful to establish the exact switch position in an interactive manner.

For example, when not all wells contain specimens, but this distinction cannot be deduced From a preview image, but the user knows which wells are relevant and which are not, the user may provide the positions of the specimen-free wells for the objective switch.

If the user is using vessels with an identical design, one-time definition and storage of the switch zones is also possible; i.e., when the next specimen is inserted, an automated microscope can retrieve and use these positions without the need for a re-determination of the switch zones by interactive means or for each preview image.

As stated above, after the objective switch the microscope stage or the objective is customarily moved back to its starting position, so that the same portion of the specimen that has previously been observed with the immersion objective may subsequently be observed with the dry objective or also with a different immersion objective. However, this does not necessarily have to be the case in a complex experiment.

Prior to the objective switch, it is also possible that a larger area of the specimen, or a plurality of noncontiguous individual locations, has been observed with the immersion objective. All of these points should be observed anew alter the objective switch. In that case it is often meaningful to move over the points again in the same sequence. The observation point immediately prior to the objective switch and the observation point directly following the objective switch may thus be very different.

The procedure according to the invention may also be carried out using a stationary microscope stage and/or an objective which is movable by motor. The objective does not necessarily have to be situated in a revolver, and instead may be mounted in some other way.

The procedure according to the invention is also applicable when a switch is to be made from one immersion objective to another immersion objective having a different immersion medium, for example a switch from a water immersion objective to an oil immersion objective. All steps then remain the same, except that at the end, the new immersion medium, in this case oil, must also be applied to the front lens. For a switch between two immersion objectives having the same immersion medium, however, the procedure is not necessary, since the residual droplet on the specimen container base may be used right away as the immersion medium for the new objective.

The invention is also independent of whether a further objective is actually to be used after the immersion objective. A complex experiment run is frequently not directly apparent, but instead arises only alter the specimen has been considered and initial preliminary examinations have optionally taken place. In addition, an immersion objective may be used. When the procedure described in the present invention is used for switching from the immersion objective, this also allows the user to subsequently configure a further experiment without being limited in any way by the immersion droplet on the specimen container base, since this droplet has been deposited at a location which in any event is not relevant for the observation.

In an automated microscope it is meaningful to link the described procedure to the end of the immersion objective use rather than to the switch from an immersion objective to a different objective. Often, the experiment is terminated after using the immersion objective. However, a solution must then be found for removing the remaining immersion medium. This may take place at the instantaneous stage position, using one of the known approaches of the prior art; however, this would require extra effort. It is more elegant to use the procedure according to the invention which is directly linked to the end of the immersion objective use. Thus, the user no longer has to be concerned about removing the immersion, and it is guaranteed that the equipment may be switched off without the immersion remaining. Thus, in this case, the switch position does not mean that an objective switch actually takes place at that location, but instead, that it would potentially be possible there.

### BRIEF DESCRIPTION OF THE DRAWINGS

The procedure according to the invention is explained in greater detail below with reference to three exemplary embodiments for recording specimens. The figures show the following:

FIG. 1 is a schematic illustration of a specimen container having a cover plate;

FIG. 2 is a schematic illustration of a Petri dish as the specimen container;

FIG. 3 is a schematic illustration of a microtiter plate as the specimen container;

FIG. 4 is an illustration of the procedure sequence with a displacement of the microscope stage;

FIG. 5 is an illustration of the microscopic application with an immersion objective; and

FIG. 6 is a flow chart for determining possible positions for the objective switch.

### DETAILED DESCRIPTION

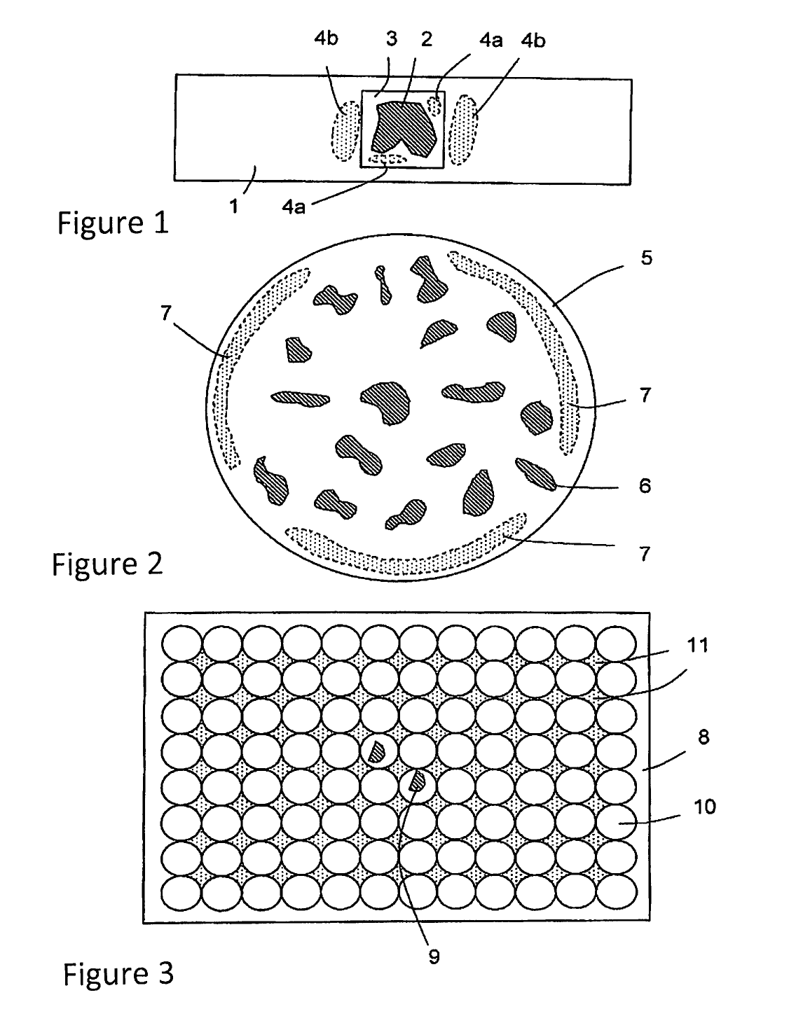

FIG. 1 shows a specimen container 1 on which a specimen 2 is present which is covered by a cover glass 3. In this example, the immersion residual droplet is deposited, and the objective switch takes place, at locations 4a or 4b, which are situated outside the specimen 2, i.e.. outside the observation position.

In another exemplary embodiment according to FIG. 2, a plurality of specimens 6 is present on a Petri dish 5.

In this case, areas 7 close to the edge are suitable for depositing the immersion medium residual droplet and for the objective switch, since these areas are often not relevant for examinations.

FIG. 3 shows a microtiter plate 8. The microtiter plate has a plurality of individual wells 10 which contain specimens 9. The number of wells varies, depending on the type of plate. Possible switch locations for the objectives are either empty wells 10 or the areas 11 between individual wells.

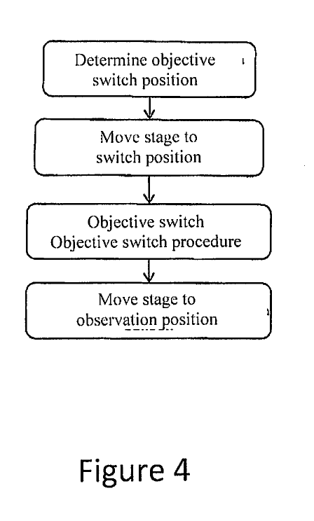

The procedure according to the invention, with the displacement motion of the microscope stage for the objective switch, is illustrated in FIG. 4, wherein initially the switch locations for the objectives are determined.

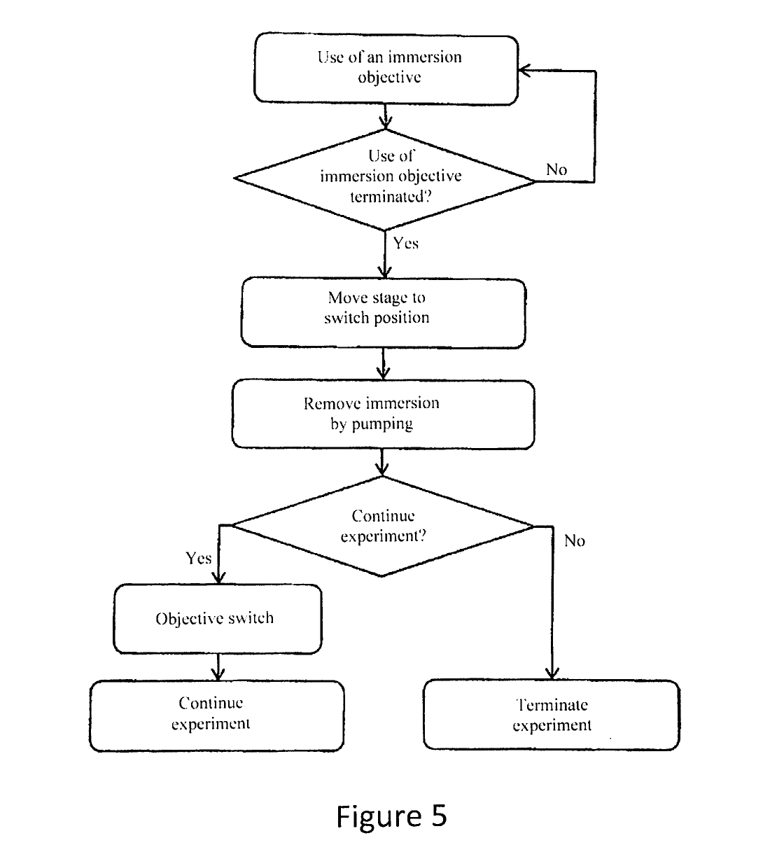

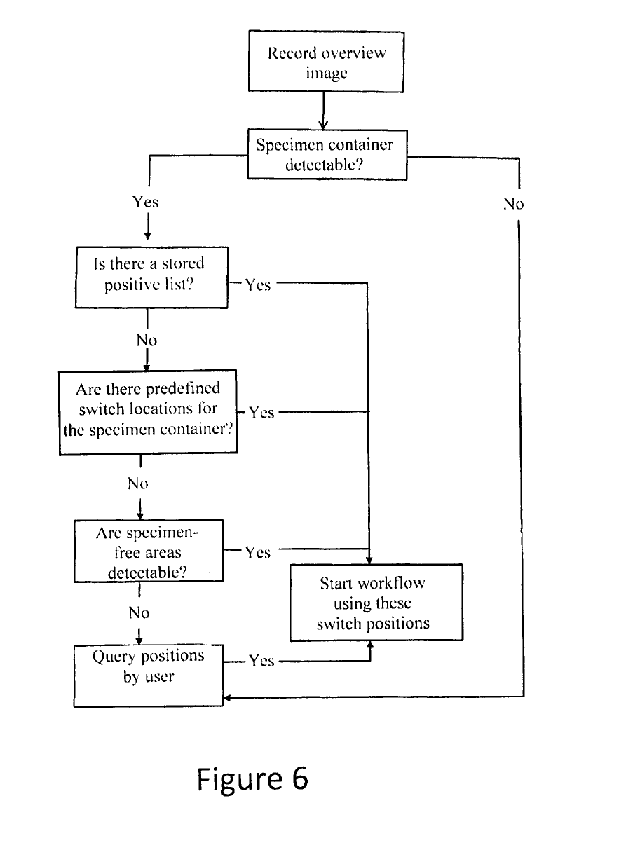

FIG. 5 shows a microscopic application (experiment) with an immersion objective. A flow chart for determining possible positions for the objective switch is illustrated in FIG. 6.

The point in time for finding the switch locations is accordingly variable. This may occur directly after recording the overview image, or only after the decision is made to begin the use of an immersion objective or after the decision is made to terminate the use of the immersion objective.

What is claimed is:

1. A method for terminating microscopic applications in microscopes having an immersion objective, wherein alter the microscopic application, the immersion objective or the microscope stage hearing a specimen and/or a specimen container is moved from an observation position, wherein immersion medium remaining on the specimen or on the specimen container is deposited at a location outside the observation position.

2. A method for terminating an application on a microscope system, the microscope system including a microscope having an immersion objective and a microscope stage, a specimen, and a specimen container, the method comprising:
creating a preview image of the specimen, or the specimen container, on the microscope stage at an observation position;
determining coordinates of the microscope stage or the objective from the preview image;
moving the microscope stage or the objective to a position of the specimen or a portion of the specimen container to a second position away from the observation position;
depositing an immersion medium residual droplet at the second position;
switching the immersion objective to a second immersion objective or a dry objective at the second position; and
moving the microscope stage, the second immersion objective, or the dry objective back to the observation position.

3. The method according to claim 2, wherein the switch of the objectives takes place outside the specimen container.

4. The method according to claim 2, wherein the immersion medium residual droplet is deposited outside the specimen container.

5. The method according to claim 2, wherein the immersion medium residual droplet is deposited on a specimen container holder.

6. The method according to claim 2, wherein the switch of objectives takes place in a non-covered area of the specimen container.

7. The method according to claim 2, wherein the switch of the objectives takes place in a covered area of the specimen container away from the specimen.

8. The method according to claim 2, wherein the switch of the objectives takes place in a non-relevant edge area of a Petri dish.

9. The method according to claim 2, wherein the switch of the objectives takes place above empty wells of a micro-titre plate or in an area between wells of a micro-titre plate.

10. A method according to claim 2, wherein the steps are carried out in an automated manner.
